(19) United States
(12) Patent Application Publication
(10) Pub. No.: US 2012/0230795 A1
(43) Pub. Date: Sep. 13, 2012

(54) Load Protection Bar

(76) Inventor: Gabriel Hernandez, Las Banos, CA (US)

(21) Appl. No.: 13/043,693

(22) Filed: Mar. 9, 2011

(51) Int. Cl. B60P 7/15

(52) U.S. Cl. 410/151

(57) ABSTRACT

A load protection bar for securing cargo comprising: a cylindrical body; an adjusting extension, where said extension extends from one end of the cylindrical body; and a means to adjust the length of the adjusting extension. The means to adjust may include a hand-cranking handle. The load protection bar may further include a foot at one end of the body and a foot at the end of the adjusting extension, where each foot is made of plastic.

### BACKGROUND OF THE INVENTION

1. Field of Invention

The present invention relates to a device utilized to support and protect a cargo load within a cargo container and to prevent the load from falling during transport

2. Description of Related Art

Shipment of cargo and goods is principally achieved through the use of cargo trucks and tractor-trailer type vehicles. Usually the cargo is placed in a large container that is attached to a truck where the truck is a suitable size and power to transport the cargo to its destination. A common problem associated with cargo shipment involves the shifting and movement of the cargo load when transporting the goods. These goods are normally placed in the rear cargo area of the truck and consequently shift around during the transporting of the goods. Various restraint devices have been developed to help restrain, brace or support the cargo during movement of the vehicle. The braces and other devices help to prevent the movement of the cargo during the transport. Use of these braces can assist in the preventing in the damage and movement of cargo and one principal device involves the use of load bars that are placed within the cargo compartment to brace and support the cargo during movement. The conventional load braces have been developed in the various forms in the prior art. Once such cargo bar is described in U.S. Pat. No. 6,186,715, which discloses a cargo bar equipped with adjustable mechanism for limiting the force that can be exerted by a ratchet that serves to secure the cargo bar in place extending between opposing surfaces of a truck body. Another load bracing bar is disclosed in U.S. Pat. No. 4,349,70, which discloses a load bracing bar frictionally supported between partitions to restrain cargo movement comprising a elongated bar consisting of telescoping interconnected portions. Many of the cargo bars of the prior art are locked into place within the cargo compartment and therefore are principally lacking in the necessary flexibility to effectively support and secure the cargo especially when various sizes of goods were being shipped. Therefore a convenient portable load brace is needed to secure cargo within a shipping compartment.

### SUMMARY OF THE INVENTION

The present invention relates to a load protection bar for securing cargo comprising: a cylindrical body; an adjusting extension, where said extension extends from one end of the cylindrical body; and a means to adjust the length of the adjusting extension. The means to adjust may include a hand-cranking handle. The load protection bar may further include a foot at one end of the body and a foot at the end of the adjusting extension, where each foot is made of plastic.

### BRIEF DESCRIPTION OF DRAWINGS

FIG. 1 depicts a load protection bar in accordance with the present invention.

### DETAILED DESCRIPTION

The present invention relates to a load protection bar utilized to protect and secure cargo within a cargo container. The present invention includes a turn handle that adjusts the length of lower protection bar and allows for each end of the bar to be securely abutted to the cargo and/or sides or bottom of the cargo container. The load protection bar according to present investigation includes a hand crank that may easily retract, extend and adjust the length of the bar as needed to effectively secure the cargo within the cargo container.

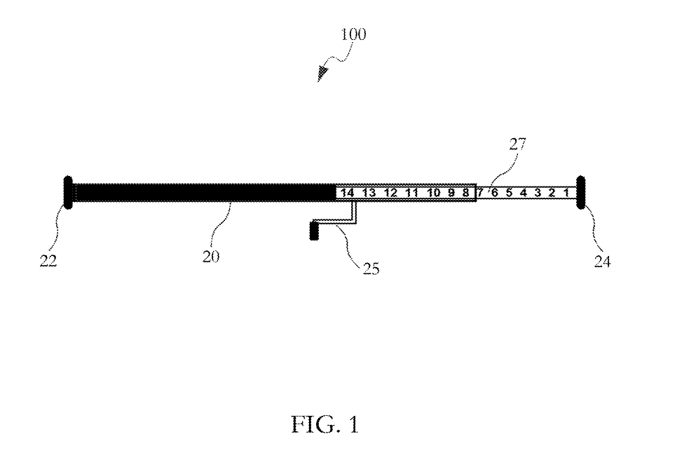

In reference to FIG. 1, a load protection bar 100 according to the present invention is depicted. A load protection bar 100 includes a cylindrical body 20 with an adjusting Extension 27. The adjusting Extension 27 extends out of one end of the cylindrical body 20 and provides a means to adjust the length of the bar for the load protection. At the end of the adjusting Extension 27 is a foot 24 which may abut to the side of the cargo or against the cargo container. At the opposite end of the load protection Bar 100 is a Foot 22, which is attached to one end of the cylindrical Body 20. A crank Handle 25 is provided within the cylindrical Body 20 that allows the user to adjust the length of the load protection Bar 100. Each foot, Foot 22 and Foot 24, may be manufactured of plastic materials so that the devices may easily grip any surface without scuffing or damaging the surface. Further the cylindrical Body 20 may be manufactured of steel tubing to allow for the insertion of the adjusting Extension 27. The load protection Bar 100 is a functional device that easily supports cargo within a cargo container and may be applied in both horizontal and vertical applications. In one particular embodiment, the load protection bar may extend from 95 to 107 inches as one exemplary range of the load protection bar according to present invention.

Use of the load protection bar according to present invention helps to secure packages and goods within a cargo container and helps to alleviate unnecessary damage during the shipment of cargo. The load protection bar locks into a particular position through the use of a hand-cranking handle and may be used in a cargo loading application. The instant invention has been shown and described in what it considers to be the most practical and preferred embodiments. It is recognized, however, that departures may be made there from within the scope of the invention and that obvious modifications will occur to a person skilled in the art.

What is claimed is:

1. A load protection bar for securing cargo comprising:
a. a cylindrical body;
b. an adjusting extension, where said extension extends from one end of the cylindrical body; and
c. a means to adjust the length of the adjusting extension.

2. The load protection bar according to claim 1, where the means to adjust includes a hand cranking handle.

3. The load protection bar according to claim 1, further including a foot at one end of the body and a foot at the end of the adjusting extension.

4. The load protection bar according to claim 3, where each foot is made of plastic.

5. The load protection bar according to claim 1, where the cylindrical body and adjusting extension are made of steel.

6. The load protection bar according to claim 1, where the length of the bar ranges from 95 inches to 107 inches.
